(19) United States
(12) Patent Application Publication
(10) Pub. No.: US 2013/0333492 A1
(43) Pub. Date: Dec. 19, 2013

(54) TEST DEVICE FOR A LIQUID DISPENSER

(71) Applicants: Matthias WOCHELE, Rielasingen-Worblingen (DE); Matthias BIRKHOFF, Kevelaer (DE)

(72) Inventors: Matthias WOCHELE, Rielasingen-Worblingen (DE); Matthias BIRKHOFF, Kevelaer (DE)

(21) Appl. No.: 13/915,133

(22) Filed: Jun. 11, 2013

(30) Foreign Application Priority Data
Jun. 15, 2012 (DE) 10 2012 210 143.8

(51) Int. Cl. G01N 19/00

(52) U.S. Cl. CPC G01N 19/00
USPC 73/865.9

(57) ABSTRACT

A test device for a liquid dispenser including a base for stationary placement of the test device, a receiving device for receiving a liquid dispenser, and an actuation device configured for mechanical actuation of the liquid dispenser received in the receiving device. The test device is configured as a test device for a drop dispenser, wherein the receiving device and the actuation device are configured and arranged such that the drop dispenser can be received and actuated in a position where a discharge opening of the drop dispenser faces downwards.

### CROSS REFERENCE TO RELATED APPLICATION

This application claims priority from German Application No. 10 2012 210 143.8, filed Jun. 15, 2012, the disclosure of which is hereby incorporated by reference in its entirety into this application.

### FIELD OF APPLICATION AND PRIOR ART

The invention relates to a test device for a liquid dispenser according to the preamble of claim 1.

Such a test device comprises a base for stationary placement of said test device. Furthermore, it comprises a receiving device, which is provided for receiving a liquid dispenser, as well as an actuation device configured for mechanical actuation of the liquid dispenser received in the receiving device.

The field of application of such test devices are liquid dispensers, which may serve for discharging of primarily pharmaceutical, however also cosmetic liquids, where required. Such test devices allow actuating the corresponding liquid dispensers in a defined manner after being received in the receiving device in order to examine the discharge performance thereof.

Such test devices have already been known from patent documents of the Proveris Scientific Corporation company. Thus, U.S. Pat. No. 7,658,122 B2 discloses such a device which is configured for actuation of a so-called spray dispenser. In the case of such a dispenser, the liquid is atomized into a spray jet in the course of the discharge. The well-known test devices in particular serve the purpose of examining the spray jet in terms of its shaping and the size of the droplets generated.

Known test devices have proved to be useful in practice. Involving comparatively low effort, said test devices permit examining prototypes of liquid dispensers or dispensers taken from each production batch of the serial production as to whether said dispensers are working according to the desired specifications.

Besides such dispensers configured for discharging the liquid as a spray jet or in an atomized manner, also drop dispensers are known from the prior art. In this case, in the context of the present document, a drop dispenser refers to a dispenser which comprises a drop formation surface at its exterior side, wherein by actuation of the drop dispenser, liquid from the liquid reservoir of the drop dispenser can be guided to said drop formation surface, which liquid accumulates there until the drop disengages from the dispenser due to its weight. An example for such a drop dispenser is known from DE 10 2010 047 840. Such drop dispensers are frequently configured such that they comprise a so-called squeeze bottle, that is, a plastic bottle that can be manually compressed from the outside, where the discharge is caused by the compressing of the bottle.

Such test devices for examining such drop dispensers have not been known until now. As a result, the effort for examining such drop dispensers is comparatively high. In particular, generation of reproducible actuation conditions and evaluation conditions presents a problem.

### OBJECT AND SOLUTION

Therefore, it is the object of the invention to provide a means for examining such drop dispensers.

The object underlying the invention is achieved by a test device having the features of claim 1.

A test device according to the invention is configured as test device for drop dispensers. For this purpose, the receiving devices and the actuation device are configured and arranged such that the drop dispenser can be received and actuated in a position where a discharge opening of the drop dispensers faces downwards.

Thus, the basic idea of the invention described herein is to provide a test device capable of receiving and actuating a drop dispenser in a reproducible manner by means of a receiving device provided therefor. In this case, the receiving device is configured such that the discharge device can be held in the receiving device with the discharge opening facing downwards. In the context of the present description, the direction of the discharge opening refers to the direction into which liquid fed from the liquid reservoir to the discharge opening exits the discharge opening, provided the influence of gravity is neglected.

Just as the receiving device, also the actuation device of a test device according to the invention is configured such that the dispenser can be actuated in the aforementioned upside down position, i.e., the position with the discharge opening facing downwards.

The indication of the direction regarding the discharge opening is to be understood in connection with the arrangement of the base. The base can comprise an essentially plane bottom side of the test device or positioning feet provided on the bottom side or the like. The arrangement of said base defines what is understood as bottom and top in the context of the present invention.

The receiving device for receiving the drop dispenser is preferably arranged such that when the drop dispenser is inserted, a fall distance for a discharged drop remains below said receiving device. Preferably, said fall distance is at least 30 mm, particularly preferable at least 60 mm. The fall distance can be limited downwards by means of an impact plate in a manner subsequently explained.

The receiving device preferably comprises a hole at its lower end, for example on a bearing plate of the receiving device, through which hole the fall distance of the drop is running or through which a lower part of the drop dispenser including the discharge opening is pushed through from above. In the case of a drop dispenser having a squeeze bottle which according to the intended use can be deformed for discharging, only a rigid dosage assembly group adjacent to said squeeze bottle is inserted through the hole.

The receiving device is arranged and configured such on the test device in the afore-described manner that the discharge opening of the drop dispenser received faces downwards.

In this case, an orientation downwards refers to an orientation which includes an angle smaller than 30° with a vertical orientation relative to the base. Preferably, the receiving device permits receiving of the drop dispenser where said angle is smaller than 15°, preferably 0°.

In the case of a particularly preferred configuration, the receiving device is movable in its entirety, in particular pivotably movable. In this case, movability or pivotability in the entirety refers to the feature that the receiving device with the drop dispenser received therein can together be moved relative to the base. Preferably, here also the actuation device is co-moved, so that the relative position of the actuation device to the drop dispenser remains unchanged due to the movability of the receiving device.

The pivotability of the receiving device preferably allows variation of the pivot position of the receiving device by at least 10° without that the drop dispenser would have to be separated from the receiving device for this purpose. Thus, said pivotability of the receiving device allows discharge of drops not only in an initial position where the direction of the discharge opening is preferably oriented vertically, but also in positions slightly pivoted thereto, in order to thereby also be able to simulate variations in handling by different users. The movability of the receiving device can also be used to remove a remaining drop from the drop dispenser after a discharge procedure, as will be explained in the following.

The movability, in particular the pivotability, of the receiving device can be provided for direct manual manipulation. However, it is also possible to provide a motor which moves, in particular pivots, the receiving device controlled by means of a control device.

The actuation device which is provided in the case of a test device according to the invention serves in particular for electromotive actuation of the drop dispenser. Thus, it comprises at least one motor which can, controlled by a control device, displace an actuator, which applies an actuation force to the drop dispenser or to an actuation surface of the same.

In the case of a particularly preferred embodiment, the at least one actuator of the actuation device is configured as to apply a force to the drop dispenser by means of the actuator orthogonally or essentially orthogonally (+/−)20° to the discharge direction of the discharge opening of the drop dispenser. Thus, in such a case, the actuation device is arranged on or in the region of the receiving device such that when receiving a drop dispenser, the discharge opening of said dispenser faces downwards, an actuation by means of the actuator is effected horizontally or almost horizontally. As a result, it is possible to also examine drop dispensers by means of the test device according to the invention, which dispensers are configured as so-called “side actuation” dispensers, i.e. include approximately a right angle between the actuation direction and the discharge direction.

In particular, it is of advantage if at least two actuators are provided which are configured to apply a force to the drop dispenser in directions opposed to one another. Thus, in such a case, two actuators movable relative to other parts of the receiving device are provided capable of being approached to another by electro-motoric means, wherein the movement directions of the actuators include an angle between 150° and 210°. Such an actuator configuration allows actuating dispensers that are configured with a so-called “squeeze bottle”. In this case, configurations are conceivable where to each actuator a distinct electromotor is assigned as well as configurations where a transmission distributes the driving force of an electromotor to both actuators.

The actuators are those parts of the actuation device getting into immediate contact with the drop dispenser. While in the case of a drop dispenser having a per se non-deformable actuation button movable in relation to the base body of the drop dispenser it is usually not important how the actuator applying said actuation button with force is shaped, in the case of a deformable actuation surface on the drop dispenser the force application is much more dependent on the shaping of the actuator as such. Therefore, it is proposed to configure the actuator with a contact region at its end facing towards the drop dispenser, which region is formed to be convex, which in particular has a convex curved shape, and/or which is formed of a plastically deformable material, in particular with a modulus of elasticity of less than 200 N/mm². Both measures, on their own or in combination, serve the realistic simulation of actuation by means of human fingers.

A convex shaping refers to a shaping where partial regions of the contact region relative to the actuation direction of the respective actuator are offset against one another. This could, for example, be achieved by means of an essentially cylindrical actuator having a circumferential chamfer provided externally on the end face. A particularly preferred form lies with the configuration having a convex curved end face, wherein in this case, the curvature radius should approximately be similar to that of the human finger, that is, between 5 mm and 15 mm on average.

Alternatively or additionally, configuration with a contact region made of a plastically deformable material is possible. Thus, for example rubber caps, in particular with the aforementioned curved shape, are well suitable in order to simulate the actuation and in particular the force distribution involved at the actuator similar to that caused by human fingers.

Instead of two actuators movable relative to a main body of the receiving device, also only one of the actuators can be configured to be movable while the other one is stationary to the receiving device and provides a counter face for receiving the force application of the one moved actuator. In such a case, the receiving device can also be configured to permit a displacement of the drop dispenser relative to the receiving device transversally (+/−)20° to the direction of the discharge opening.

In order to allow the movement of the drop dispenser transversally to the direction of the discharge opening without any problems, the receiving device can be equipped with horizontally extended guide rails or the like, and extensions of the dispensers to project therein.

Thus, the test device according to the invention described herein is characterized by a configuration which is particularly suitable for receiving and actuating a drop dispenser. In particular for the purpose of examining the discharge performance of drop dispensers, which are examined by means of the test device, the following measures are provided.

Thus, it is considered to be advantageous if a test device according to the invention comprises a receiver to remove the so-called remaining drop after a discharge procedure, which drop remains at the drop formation surface of the drop dispenser after discharge of a drop due to gravity. Said remaining drop, the volumetric minimization of which is one of the aims of drop dispenser developers, remains on the exterior of the drop dispenser after the discharge procedure with most drop dispensers, since said drop should not be drawn back into the dispenser in order to prevent contamination. As to ensure that said remaining drop of a discharge procedure does not influence a consecutive measuring and also in order to indirectly determine the volume of the remaining drop, a test device according to the invention preferably comprises a receiver for removing said remaining drop.

In this case, two configurations are considered to be particularly advantageous. Thus, it is possible that the test device comprises a receiver which can be moved into a receiving position underneath the dispenser for removal of the remaining drop. As an alternative, it is possible to configure the receiving device to be movable such that the dispenser can be moved up to a receiving position where a receiver is provided the remains stationary relative to the base during a test procedure. Another variation provides that the test device comprises a device for generating an air jet by means of which a remaining drop that remained at the discharge opening of the dispenser can be removed.

Thus, the first configuration is designed such that a receiver movable relative to the base, for example pivotable, is provided, which receiver is displaced into the region of the discharge opening after a drop discharge procedure in order to remove the remaining drop at this point. The second variant provides that the receiving device per se is configured to be movable, for example pivotable, so that it can move the drop dispenser up to a position where a stationary receiver is arranged during the test procedure, which receiver removes the remaining drop from the dispenser.

In both cases it is possible to configure the receiver as a simple contact face onto which the remaining drop slips over due to the gravitational force when approaching the receiver to the drop formation surface. As an alternative, the receiver can also be equipped with a sponge or a cushion, allowing a particularly complete removing of the remaining drop.

In the case of the third variant, the remaining drop is removed by means of an air jet generated using an air blower or a suction device.

The actuation force applied on the one or more actuator(s) is preferably detected by means of a control device. Said detection can be achieved by evaluation of the voltage and the related current applied to the respective electric motor. However, separate force meters are of advantage, which immediately detect the force application of the drop dispenser by means of the actuator(s). Said measuring device for detecting the actuation force allows, besides detection of the size, also control circuits, in order to adjust the actuation depending on the force applied.

Furthermore, the test device according to the invention preferably comprises a measuring device which detects the weight of the drop dispenser. Such a scale-type measuring device does not primarily serve the one-time detection of the weight of the drop dispenser, since said weight is usually known and could also be detected without the test device being involved. However, in advantageous manner, the measuring device allows detecting the size of a discharged drop by means of the weight difference prior to and after the discharge. In this case, by means of measuring three times prior to the discharge, after the discharge and after the aforementioned removal of the remaining drop, the size of the remaining drop that remained at the drop dispenser after the discharge procedure can be detected very exactly.

Further sensors considered to be advantageous on a test device according to the invention include a measuring device for detecting the drop formation at the drop dispenser and/or for detecting the fall performance of a drop and/or for detecting the impact performance of the drop.

In this case, different variants are possible. The drop formation as well as the separation performance and the fall performance can be detected, for example by means of photoelectric sensors, capacitive or inductive sensors, which are arranged along the fall distance and in particular in the region of the drop formation face of the drop dispenser. By using multiple of such sensors, also the velocity of falling can be detected. Another option for detecting the drop formation, the fall performance and the impact performance can be provided by means of a camera which monitors the discharge opening of the drop dispenser and/or the fall distance arranged underneath the discharge opening. Due to the largely unchangeable region observed by the camera, a pattern recognition which for example detects the separation time of the drop or the falling speed thereof can easily be realized. Such a pattern recognition could be effected by means of a microprocessor related to the control device.

The aforementioned measuring devices for detecting the drop formation on a capacitive, inductive or optical basis can be supplemented or substituted by the measuring device for detecting the weight of the drop dispenser. Said measuring device likewise allows detecting the separation time due to the weight reduction involved.

Furthermore, an impact surface underneath the discharge opening is advantageous. Said surface is preferably provided at least 30 mm, particularly preferable at least 60 mm underneath the receiving device and/or the discharge opening of the drop dispenser. A measuring device is assigned to the impact surface, by means of which the properties of the drops impacting thereon can be detected, in particular the impact force of the drop and the weight thereof. Said measuring devices can also be comparatively simple force sensors.

A test device according to the invention preferably comprises an electronic control device for controlling the actuation device and/or for controlling the receiving device and/or for controlling the receiver for removal of the remaining drop. Said control device is preferably also responsible for evaluating the signals of the different, aforementioned measuring devices and sensors.

Even though such a control device could also be formed by a common personal computer (PC) provided separately from the test device and connected thereto for example via Universal Serial Bus (USB), it is considered to be preferable if a test device directly integrated in the control device is used, which allows an autonomous use of the test device.

However, it is considered to be convenient if the test device can be connected to a PC or a data network in order to integrate said test device seamlessly into the production process. For example, this permits to mark production batches in a database correspondingly if a dispenser taken for testing the production batch does not perform within the predefined tolerances. Data transmission between the test device and a PC provided for data acquisition is preferably effected via Extensible Markup Language (XML).

A control device configured for executing one or multiple of the following programs is particularly preferred:

Thus, a program for operating the control device executed by means of the control device can be configured such that it controls the actuation device with a predefinable force characteristic, a predefinable speed characteristic or related to other predefinable parameters.

Moreover, the program for operating the control device can preferably allow that the control of the actuation device is effected depending on output values of aforementioned measuring devices or sensors. Thus, a response to a rise in the required actuation force for moving the at least one actuator at a predefined speed could involve an increase of the actuation force by means of the control device. Likewise, reducing the actuation force with increasing counterforce is possible. This way, different, typical human actuation profiles can be tested with different dispensers.

Likewise, a configuration of the control device considering the output values of the measuring device and sensors would be suitable for responding to the discharge of a drop using different ways and means, for example by immediate omission of the actuation force on the actuator or the actuators, respectively.

A program of the control device could also provide that the drop discharge is effected consecutively in different orientations of the drop dispenser, which orientations can be actuated automatically by means of a motor-driven receiving device. As a result, it would for example be possible to check whether the shape of a drop formation surface leads to significantly different drop sizes depending on the angle of the drop dispenser or whether the remaining drop remaining at the drop dispenser is significantly influenced thereby.

Furthermore, it is of advantage if the control device is capable of conducting test series including a multiplicity of test runs with in each case at least one drop discharge, wherein the corresponding program of the control device is preferably also configured to detect threshold actuation rates and when said rates are surpassed, there is no more collection of the drop on a drop formation surface of the drop dispenser, but the discharged liquid separates from the dispenser immediately after passing through the discharge opening.

Also test series by means of which the discharge performance at different angles between a vertical line and the discharge direction of the discharge opening for the same drop dispenser are examined, may conveniently be conducted in an automated manner by means of the control device. Thus, it would be conceivable, for example, that multiple discharge procedures are conducted with an orientation of the discharge opening varied in each case by 5°, where values regarding the drop formation per se and the developing drop are detected. A value to be mentioned in an exemplary manner is the required actuation force for separation of a drop depending on the pivoting position of the drop dispenser and the discharge opening thereof.

A special form of a test device according to the invention provides that the receiving device and thus also the drop dispenser received therein is capsulated relative to an external environment, so that in the resulting internal space variable temperature and humidity conditions can be generated. As a result, in case of a sufficiently exact measuring device for detecting the weight of the drop dispenser, also the time period can be detected that it takes until a remaining drop on the drop formation surface is removed by drying.

Furthermore, the invention relates to a test device of the afore described type including a drop dispenser received therein, in particular a drop dispenser, with the actuation direction thereof being orthogonal to the direction of the discharge opening, or a drop dispenser which is configured with a squeeze bottle. In the manner yet described above, said drop dispenser is arranged in the receiving device such that its discharge opening faces downwards (+/−)30°.

A test device according to the invention is in particular used for testing the discharge performance of a pharmaceutical or medical drop dispenser, in particular an eye drop dispenser, in particular a dispenser for treatment of increased intraocular pressure, for treatment of dry eyes or for treatment of allergies or inflammations.

In particular, said dispenser is a dispenser for discharging drugs which contain formulas in liquid dosage form of molecule groups common in ophthalmology. In this case, these are mainly the molecule groups alpha-2-agonists (e.g. brimonidine), prostaglandin analogues (e.g. tafluprost, latanoprost, bimatoprost, travoprost), beta blockers (e.g. timolol) and carbonic anhydrase inhibitors (e.g. dorzolamide), furthermore hyaluronic acid based compounds, film formers in general (e.g. methylcellulose compounds) and cyclosporine as well as antihistamines (e.g. olopatadine and levocabastine), steroids (e.g. loteprednole and dexamethasone) and non-steroidal anti-inflammatory drugs (NSAID) (e.g. ketorolac).

In order to examine greater numbers of drop dispensers, it is considered to be advantageous if a component placement robot is assigned to the test device or to multiple of such test devices, which robot removes drop dispensers to be tested from a repository and supplies them to the test device. Such a system requires a control device which, timed to the test procedures, supplies further drop dispensers using the robot. The control of the robot can likewise be effected via the control device of the test device.

### BRIEF DESCRIPTION OF THE DRAWINGS

Further aspects and advantages of the invention arise besides from the claims from the following description of a preferred exemplary embodiment of the invention, which is explained by means of the figures. Here, the figures show in:

FIGS. 1 and 2 a front view and a side view of a test device according to the invention in an overall illustration,

FIG. 3 to FIG. 6 a test procedure conducted using the test device of the FIGS. 1 and 2, and

FIG. 7 a slightly modified variant of the test device of the FIGS. 1 to 6.

### DETAILED DESCRIPTION OF THE EXEMPLARY EMBODIMENTS

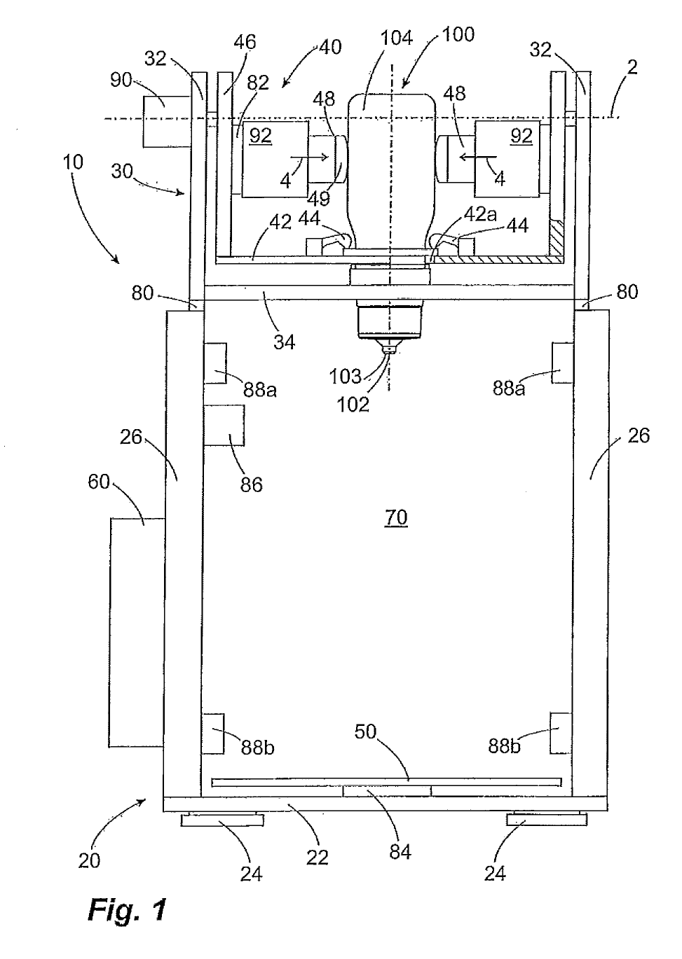

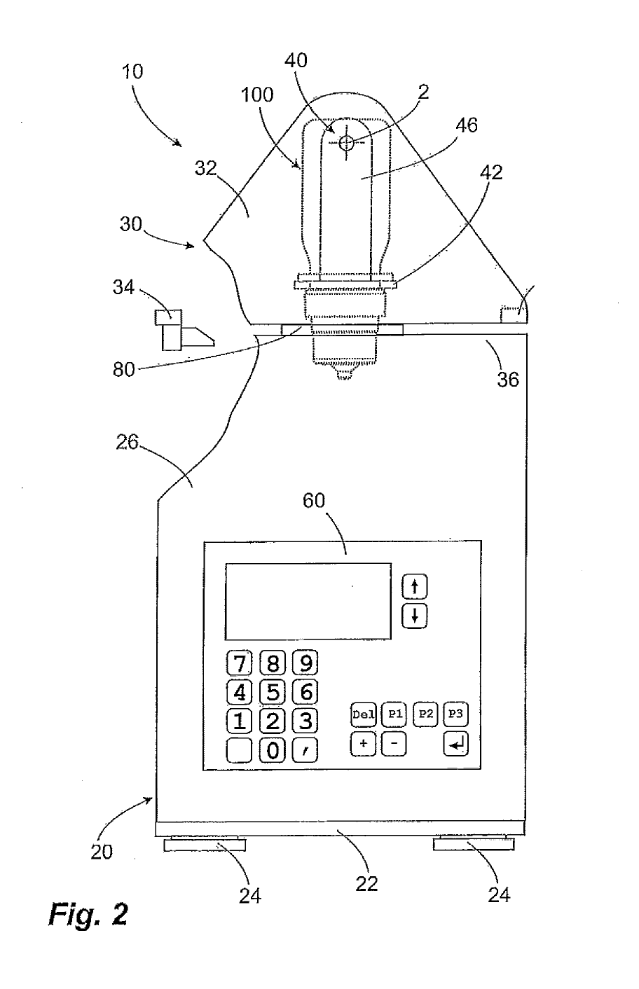

FIGS. 1 and 2 show a test device 10 according to the invention in schematic illustration and in each case partially sectional.

The test device 10 comprises a base 20 provided for stationary placement. Said base 20 is provided for stationary placement, for example on a table surface, and comprises, to that end, four positioning legs 24 on a bottom plate 22. From the base plate 20 two side walls 26 extend upwards, which include a fall distance region 70 between them that will be described subsequently.

A frame 30 extends adjacent to the upper end of the side walls 26, which frame comprises two gable sections 32, which are aligned with the side walls 26, and two crossbars 34 connecting the gable sections 32. The frame 30 rests on two force sensors 80 which are arranged between the side walls 26 and the frame 30, and which are for measuring of the weight of a drop dispenser to be tested in a manner described in the following. Between the gable sections 32 of the frame 30, a nacelle-type receiving device 40 is provided which is pivotably movable around a pivot axis 2 relative to the frame 30. An electric motor 90 is attached to one of the gable sections 32 for pivoting said receiving device 40. The nacelle-type receiving device 40 comprises a bearing plate 42 with a through hole 42a as well as a fixing means, which in the present case are formed by means of two clamping devices 44. The through hole 42a and the clamping devices 44 allow attaching a drop dispenser 100 to the nacelle-type receiving device 40 such that the discharge opening 102 of said drop dispenser 100 faces vertically downwards. The drop dispenser 100 of the exemplary embodiment is provided with a squeeze bottle 104 which extends upwards from the bearing plate 42 and which is compressed for the purpose of drop discharge.

In order to allow such an actuation in an automated manner, linear motors 92 are provided at the receiving device 40 by means of which the actuators 48 in each case assigned to the linear motors 92 can be displaced in the direction of the arrows 4. The actuators per se are provided with contact sections 49 at their end provided for force application to the squeeze bottle 104, which sections have a curved end face made of rubber in order to hereby allow the force application of the squeeze bottle 104 in a similar way as effected by fingers of the human hand.

The linear motors 92 are attached to lateral cheek faces 46 of the nacelle-type receiving device 40 wherein in each case force measuring devices 82 are provided between said lateral cheek faces 46 and the linear motors so that the force applied to the squeeze bottle 104 can be detected at any time.

Above the base plate 22 of the base 20, an impact plate 50 is provided. Between said impact plate 50 and the base plate 22, also a force sensor 84 is arranged, to which a force is applied due to the impact of drops on the impact plate 50.

Furthermore, the test device 10 shown comprises a series of further sensors or measuring devices, which just as the aforementioned sensors or measuring devices are connected to a control device 60 yet to be described subsequently. Said sensors and devices include a camera 86, which is arranged such that is can detect a drop formation surface 103 of the drop dispenser 100 as well as the fall distance 70 of the major part of the fall distance 70. Furthermore, photoelectric sensors 88a, 88b are provided on the side walls 26, wherein in each case a photoelectric sensor 88a is provided in the region of the drop formation face 103 and a photoelectric sensor 88b is provided immediately above the impact plate 50.

The upper photoelectric sensor 88a is arranged such that its light path is interrupted during the drop formation and released again in the course of the separation of a drop from the drop dispenser 100. The lower photoelectric sensor 88b is arranged such that the drop can be detected shortly prior to its impact on the impact plate 50.

For evaluating the different sensors 80, 82, 84, 86, 88a, 88b as well as for controlling the motors 90, 92, a control device 60 is provided, which is illustrated in FIG. 2 in more detail. Said control device allows the entry of various parameters by means of which a test procedure can be influenced. In this case, also predefined programs of the control device can be selected, which are suitable, for example, to effect the force application to the drop dispenser 100 according to a predefined path/time characteristic. Likewise, programs can be selected here to cause a certain reaction to the separation of the drop, such as for example an immediate omission of the actuation force, as soon as the drop is discharged.

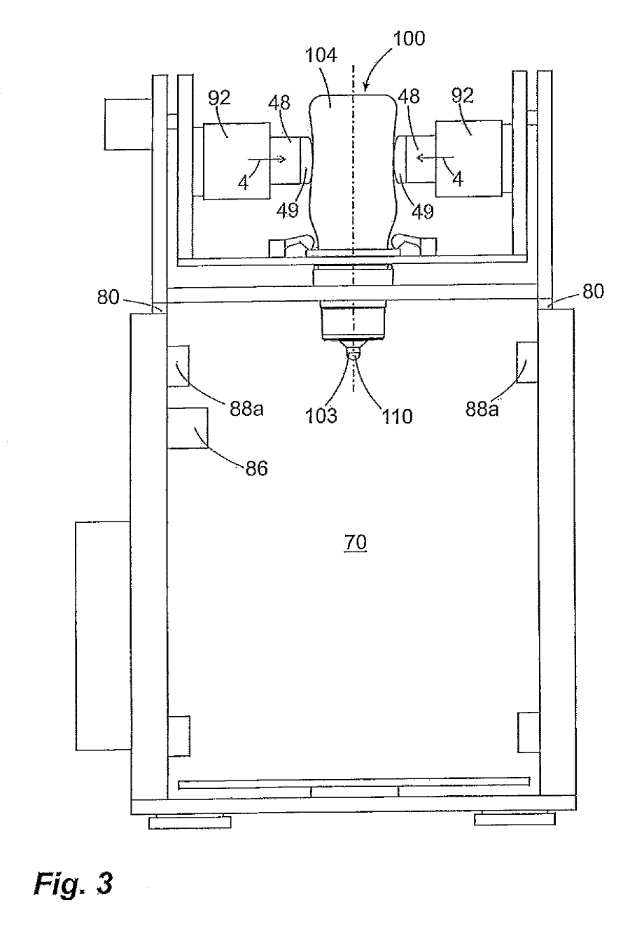

FIGS. 3 to 6 show a simple test procedure. Starting from the state of the FIGS. 1 and 2 in which the drop dispenser 100 is already clamped into the receiving device 40, however not yet applied with force, the test procedure starts in that the force sensors 80 are evaluated in order to detect the weight of the drop dispenser 100. Since the weight of the parts associated with the test device 10, namely of the frame 30 as well as the receiving device 40 of the control device 60, is known, the force applied to the force sensors 80 can be used to detect the weight of the drop dispenser 100.

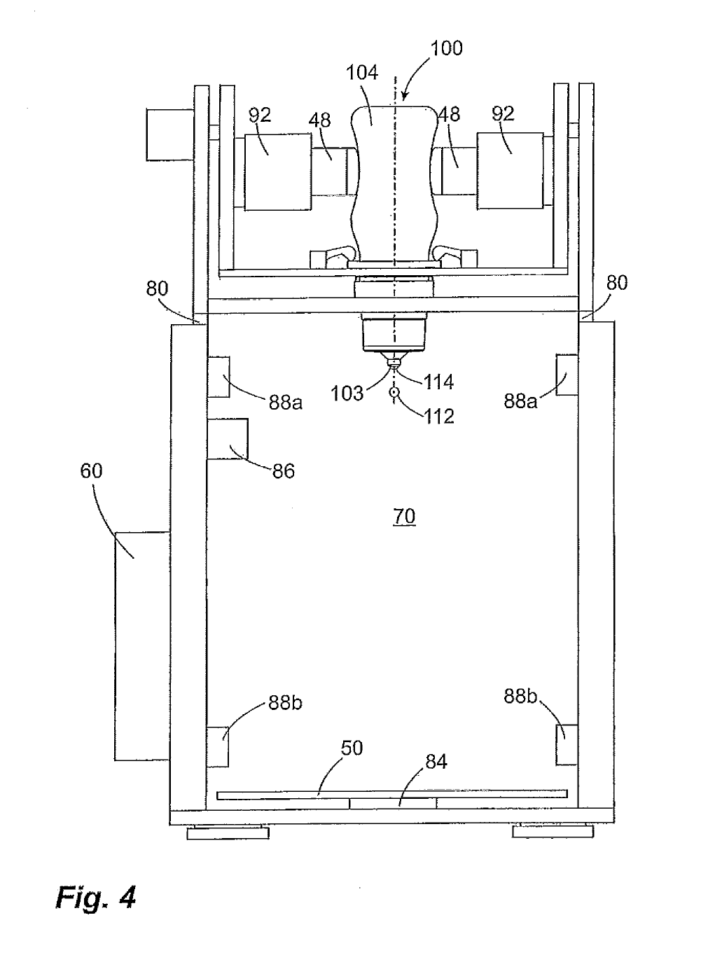

After concluding said measuring, the force application of the drop dispenser 100 starts by means of simultaneous displacement of the actuators 48 as shown in FIG. 3. Because of the shape of the contact sections 49, the force application of the liquid reservoir 104 of the drop dispenser 100 is effected in a manner very similar to the human actuation. Along with an increasing force application, a drop 110 forms at the drop formation surface 103 of the drop dispenser surrounding the discharge opening 102, which initially adheres to the drop formation surface 103. The fact that the drop formation at the drop formation face 103 has started, can be comprehended by the control device 60 by means of the upper photoelectric sensor 88a. Along with a progressed movement of the actuators 48, the volume of the drop 110 increases until a part of said drop 110 separates as fall drop 112 in the manner described in FIG. 4, while a liquid residue remains as remaining drop 114 at the drop formation surface 103. Separation of the fall drop 112 is detected by the photoelectric sensor 88, however can also be detected by the force sensors 80 instead. Together with an image recognition/pattern recognition, the camera 86 also permits to detect the separation of the drop.

After a short period of time, the fall drop 112 passes the lower photoelectric sensors 88b such that it is possible to detect its velocity. Subsequently, the fall drop 112 impacts on the impact plate 50, where the respective impulse can be detected by means of the force sensor 84.

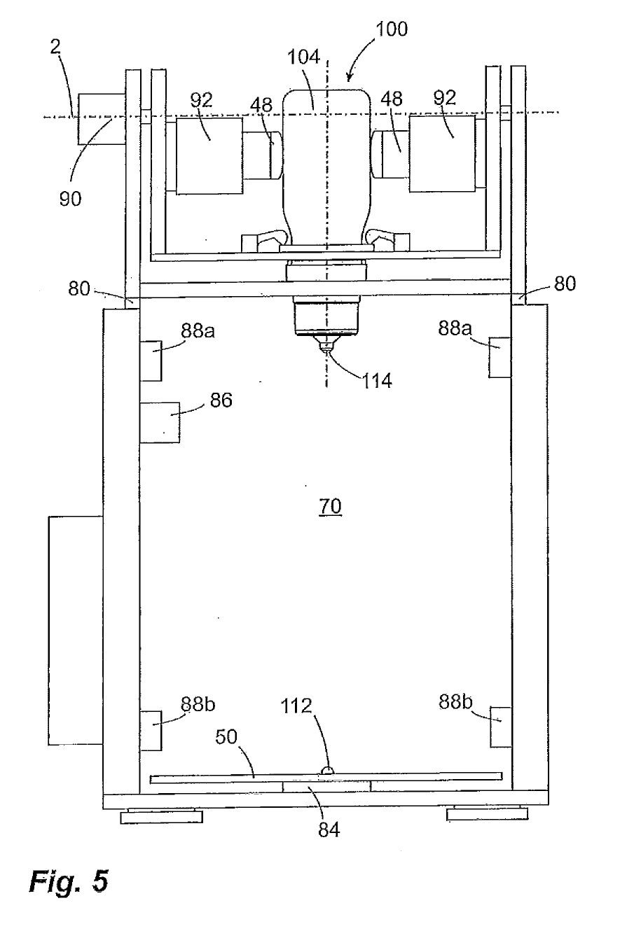

Immediately after detecting the separation of the fall drop 112 by means of the upper photoelectric sensor 88, the force application to the liquid reservoir 104 is stopped. The actuators 48 return to their basic position in the manner shown in FIG. 5.

However, the remaining drop 114 remained at the drop formation surface, since it cannot be drawn back into the bottle due to a non-return valve. After reaching the state of FIG. 5, the weight of the drop dispenser is measured again by means of the force sensors 80. Said weight is reduced by the weight of the fall drop 112 compared to the first measuring. Thus, the weight of the fall drop 112 discharged can be detected.

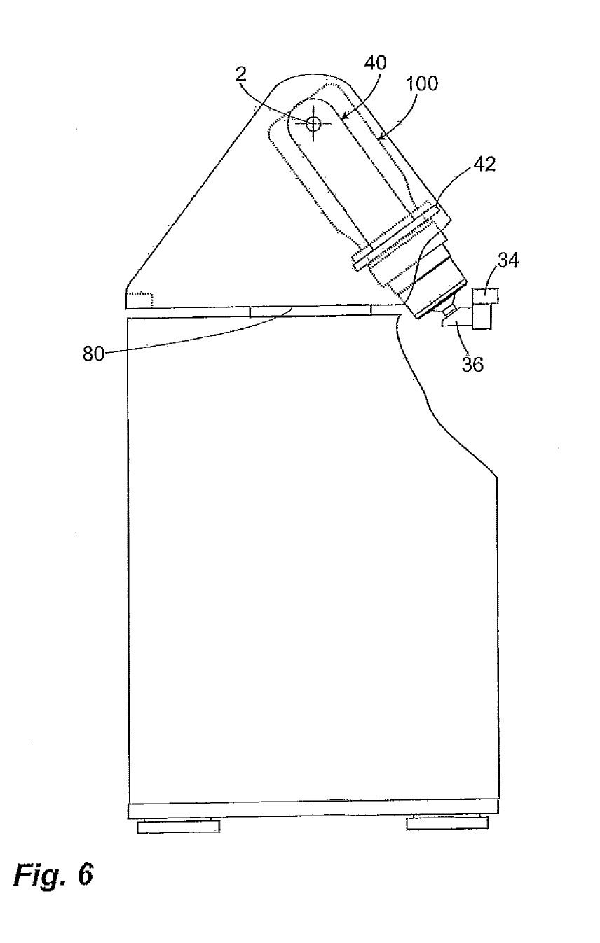

In order to now also detect the weight of the remaining drop 114, the receiving device 40 is pivoted around the pivot axis 2 by means of the motor 90 in the manner shown in FIG. 6, so that the drop formation surface 103 gets as far as into the region of a sponge-like receiver 36 attached to one of the crossbars 34. Almost the entire liquid residues at the drop formation surface 103 are removed thereby. With respect to FIG. 1, FIG. 6 shows a perspective view from the left, while FIG. 2 shows the perspective view from the right.

By means of a third measuring by means of the force sensors 80, it can now be detected which liquid amount remained as remaining drop 114 at the drop formation surface 103.

Upon pivoting the dispenser back into the initial position of FIGS. 1 and 2, another test procedure can start, which is possibly effected with a different actuation force or speed or also in a different pivoting position of the receiving device 40 around the pivot axis 2.

In the case of an embodiment not shown, the components shown of the test device are completely capsuled in relation to an environment, so that specific temperature or humidity conditions can be generated which could for example influence the time in which the remaining drop 114 dries without being removed intentionally.

Furthermore, the test device 10 can be adjusted to types of drop dispensers to be measured using different ways and means. Thus, it is possible, for example, to configure the receiving device 40 as to be exchangeable, in order to allow testing of dispensers having different dimensions or different types of actuation. Likewise, the different sensors, in particular photoelectric sensors 88a, 88b as well as the camera 86 can be attached in different positions at the base 20, in particular at the side walls 26, in preferred embodiments.

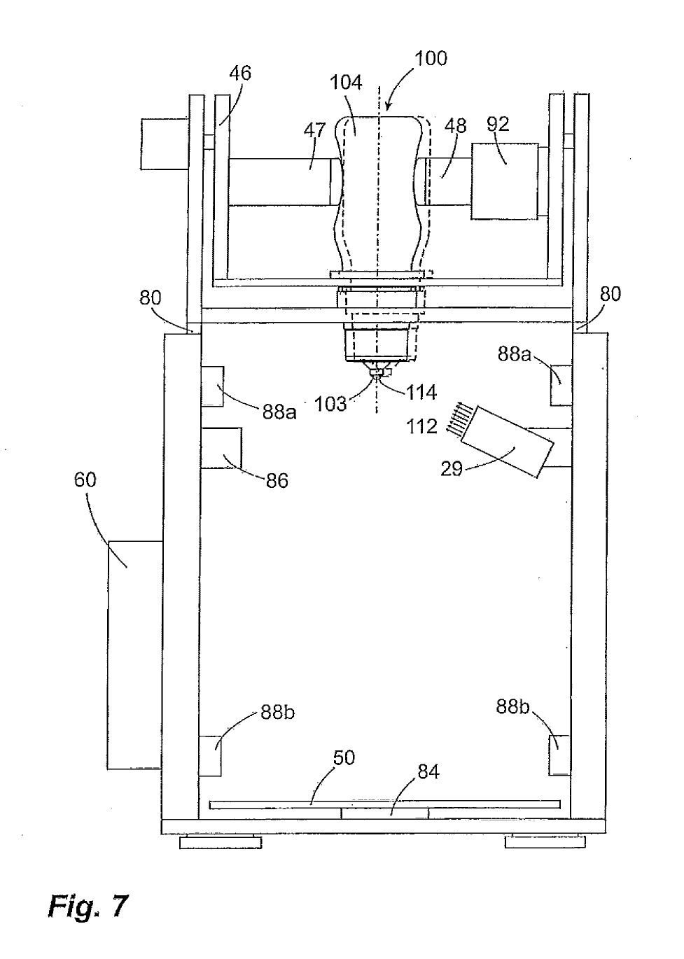

FIG. 7 shows a slightly modified variant of the test device 10. In said variant, in particular two aspects are modified, wherein said aspects can also be realized separate from one another.

On the one hand, a receiver 36 is not provided in this embodiment. Instead, an air blower 29 is located at one of the side walls 26. Said blower is capable of removing the remaining drop 114 after the discharge of a drop by means of a possibly heated air jet. Likewise, instead of an air blower, a suction device could be provided, which by means of negative pressure draws the remaining drop or removes the latter by means of the air jet streaming past the remaining drop.

On the other hand, instead of the movable left actuator 48, a fixed extension 47 connected to the lateral left cheek 46 in a fixed manner is provided, which extension does not move in relation to the lateral cheek 46. However, said extension is configured comparable to an actuator 48 in terms of its construction and likewise comprises a rubber cap at the face end.

By the provision of only one movable actuator 48, the complexity of the test device is reduced. In the case of a dispenser with a lateral actuation button, as known from DE 102009006431 A1 for example, the dispenser remains stationary during the actuation, since by means of the one movable actuator 48 merely the actuation button is pressed down. In the case of a dispenser with a squeeze bottle, there will be a displacement of the discharge assembly group and thus of the drop formation surface 103, as illustrated in FIG. 7 by means of the initial position of the drop dispenser 100 illustrated in dashed lines. However, said displacement transversally to the direction of the discharge opening is uncritical, provided the different sensors are correspondingly placed and arranged.

1. A test device for a liquid dispenser comprising
a base for stationary placement of the test device,
a receiving device for receiving a liquid dispenser, and
an actuation device which is configured for mechanical actuation of the liquid dispenser received in the receiving device,
wherein
the test device is configured as a test device for a drop dispenser, wherein the receiving device and the actuation device are configured and arranged such that the drop dispenser can be received and actuated in a position where a discharge opening of the drop dispenser faces downwards.

2. The test device according to claim 1,
wherein
the receiving device is configured to be pivotable so that the orientation of the drop dispenser received in the receiving device can be varied by at least 10° without removing said dispenser from the receiving device.

3. The test device according to claim 1,
wherein
the actuation device comprises at least one actuator for force application of the drop dispenser and is configured to apply a force to the drop dispenser by means of the actuator orthogonally to the discharge direction of the discharge opening wherein preferably the actuation device comprises at least two actuators which are configured to apply force to the drop dispenser in opposing directions.

4. The test device according to claim 1,
wherein
the actuator comprises a contact region, which region
is formed to be convex, in particular having a convex curved form, and/or
is formed from a plastically deformable material, in particular with a modulus of elasticity of less than 0.2 GPa.

5. The test device according to claim 1,
wherein
the test device comprises a receiver movable into a receiving position underneath the dispenser for a remaining drop remaining at the discharge opening after a discharge procedure, or
the receiving device is movable, in order to move the dispenser into a receiving position where a remaining drop that remained at the discharge opening of the dispenser can be removed by a receiver arranged stationary relative to the base, or
the test device comprises a device for generating an air jet, by means of which device a remaining drop that remained at the discharge opening of the dispenser can be removed.

6. The test device according to claim 1,
wherein
the test device comprises a measuring device which detects the force exerted on the drop dispenser of the actuation device.

7. The test device according to claim 1,
wherein
the test device comprises a measuring device which detects the weight of the drop dispenser.

8. The test device according to claim 1,
wherein
the test device comprises underneath the receiving device at least one measuring device for detecting the drop formation at the drop dispenser and/or the fall performance and/or the impact performance of the drop after separation from the drop dispenser.

9. The test device according to claim 1,
wherein
the test device comprises a camera for monitoring the discharge opening of the drop dispenser and/or a fall distance provided underneath the discharge opening.

10. The test device according to claim 1,
wherein
the test device comprises a sensor system for detecting the separation of a drop from the drop dispenser.

11. The test device according to claim 1,
wherein
the test device comprises a measuring device for detecting the velocity of a drop after the separation from the drop dispenser.

12. The test device according to claim 1,
wherein
the test device comprises an impact surface underneath the discharge opening, wherein to said impact surface a measuring device is assigned by means of which properties of a drop impacting on the impact surface can be detected, in particular the weight and/or the impact force of the drop.

13. The test device according to claim 1,
wherein
the test device comprises a control device for controlling the actuation device and/or for controlling the receiver for removal of the remaining drop and/or for controlling the movement of the receiving device, wherein the control device is preferably configured to work according to one or multiple of the following programs:
controlling the actuation device with a predefinable force characteristic, predefinable speed characteristic and/or predefinable actuation path,
controlling the actuation device in response to output values of one of the aforementioned measuring devices, and/or
performing a test series including a multiplicity of test runs with in each case at least one drop discharge, wherein the actuation device is actuated with variable actuation rates, in particular for detecting a threshold actuation rate where instead of a drop discharge a spray jet discharge is effected.

14. The test device according to claim 1,
wherein
a drop dispenser is received in the receiving device, wherein the drop dispenser is received such that a discharge opening of the drop dispenser faces downwards (+/−30°).

15. Use of a test device according to claim 1 for testing the discharge performance of a pharmaceutical or medical dispenser, in particular of a dispenser which is provided for
a. treatment of an increased intraocular pressure,
b. treatment of a dry eye, or
c. treatment of allergies or inflammations.
